(19) United States
(12) Patent Application Publication
(10) Pub. No.: US 2015/0365808 A1
(43) Pub. Date: Dec. 17, 2015

(54) Wireless Communication System for Human Rescue

(71) Applicant: Tzu-Hsiang Tseng, Taichung City (TW)

(72) Inventor: Tzu-Hsiang Tseng, Taichung City (TW)

(21) Appl. No.: 14/304,976

(22) Filed: Jun. 15, 2014

(51) Int. Cl. H04W 4/22; H04W 64/00

(52) U.S. Cl. CPC H04W 4/22; H04W 64/00

(57) ABSTRACT

A wireless communication system for human rescue includes a rescue coordination center and a host server database connected thereto for receiving a message from a help-caller's mobile communication device, and sending the help caller's message to rescuers' mobile communication devices. The help-caller's and the rescuer's mobile communication devices can set each other as its hot spot of a base station for Wi-Fi wireless communication so as to search rescuing SSIDs preloaded in the system, and establish connection. The distance between the two devices can be derived through the Wi-Fi connection therebetween. By using relative distances between the help-caller's mobile communication device and every rescuer's mobile communication device in different azimuths, the help caller can be accurately located, thereby reducing the time lapses before the help caller is found, increasing the help caller's survival rate, and preventing missing the golden window for rescue.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to wireless communication systems, and more particularly to a wireless communication system for human rescue that uses the magnitude of wireless signal feedback between a help caller's and rescuers' mobile communication devices to perform calculation and thereby obtain the help caller's location and direction accurately, thereby enabling efficient rescue.

2. Description of Related Arts

Various disasters may happen in people's living environment, such as fires, typhoons, earthquakes, mountain accidents, debris flow, traffic accidents, injury from falling, elevator trap, malicious attacks, and other accidents. When disasters happen, people affected long for being helped and getting out of danger as soon as possible. However, it is usually not easy for rescuers arriving at the accident sites to know the exact location(s) of people affected. Rescue is a race against the clock and any minor delay may not only cause missing the chance of saving the people affected, but also out the rescuers' life in risk. Thus, for an efficient and successful rescue task, it is most important that rescuers are able to know as much as possible information about people to be rescued and their locations. Taking an earthquake disaster for example, when people get buried alive by buildings collapsed in an earthquake and death may come any minute, rescuers have to perform inch by inch search with search auxiliaries, such as life detectors and rescue dogs. Yet use of the conventional search auxiliaries usually takes much time as the targets are not accurately identified and located, and tends to miss the so-called golden window of opportunity for rescue.

A more advanced approach to saving people's life in disasters and/or accidents is to locate a person to be rescue by using GPS (Global Positioning System) to position the person's mobile communication device. While this known approach does work to provide the help caller's location as coordinates, GPS has an inherent deviation up to a radius of 10 meters, and this deviation can hinder the rescuers from finding out the help caller effectively in the disaster site. In view that the need for efficient rescue has never been really met, the inventor of the present invention, with his years of experience in the relevant sectors, devises a system based on wireless communication technology for accurately locating a help caller by means of distance calculation.

### SUMMARY OF THE PRESENT INVENTION

The present invention herein proposes a wireless communication system for human rescue that addresses the problems existing in the prior art and is more practical and more convenient.

One objective of the present invention is using a remote host server database 20 to receive a help-calling message from a help-caller's mobile communication device 30, and send the help caller's help-calling message to a rescuer's wireless communication apparatus 40, so as to provide a rescue coordination center 10 with both the help-caller's and the rescuers' messages, thereby allowing the rescue coordination center 10 to command and deploy rescuers at the disaster site properly.

Another objective of the present invention is allowing the help-caller's mobile communication device 30 and the rescuers' mobile communication devices 401 to establish wireless communication connection via Wi-Fi (established between WLAN (Wireless Local Area Network) devices of IEEE 802.11), and using the magnitude of feedback signals of Wi-Fi signal connection between the help-caller's and every rescuer's device to determine the distance between the help-caller's and every rescuer's device. By integrating the distances obtained from the rescuers' devices at different azimuths, the help caller's location and direction can be determined accurately, so as to ensure efficient rescue during the golden window.

### BRIEF DESCRIPTION OF THE DRAWINGS

FIG. 1 is a block diagram showing the structure of a wireless communication system for human rescue according to the present invention.

FIG. 2 is a block diagram showing the structure of a help-caller's mobile communication device according to the present invention.

FIG. 3 is a block diagram showing the structure of a rescuer's mobile communication device according to the present invention.

FIG. 4 is a flowchart of the rescue mechanism at the help-caller's mobile communication device according to the present invention.

FIG. 5 is a flowchart of the rescue mechanism at the rescuer's mobile communication device according to the present invention.

FIG. 6 is a flowchart of the interactive rescue mechanism between the help caller's and the rescuer's mobile communication devices.

FIG. 7 illustrates how a help caller is located by referring to two signals.

FIG. 8 illustrates how a help caller is located by referring to three signals.

### DETAILED DESCRIPTION OF THE PREFERRED EMBODIMENT

For further illustrating the means and functions by which the present invention achieves the certain objectives, the following description, in conjunction with the accompanying drawings and preferred embodiments, is set forth as below to illustrate the implement, structure, features and effects of the subject matter of the present invention.

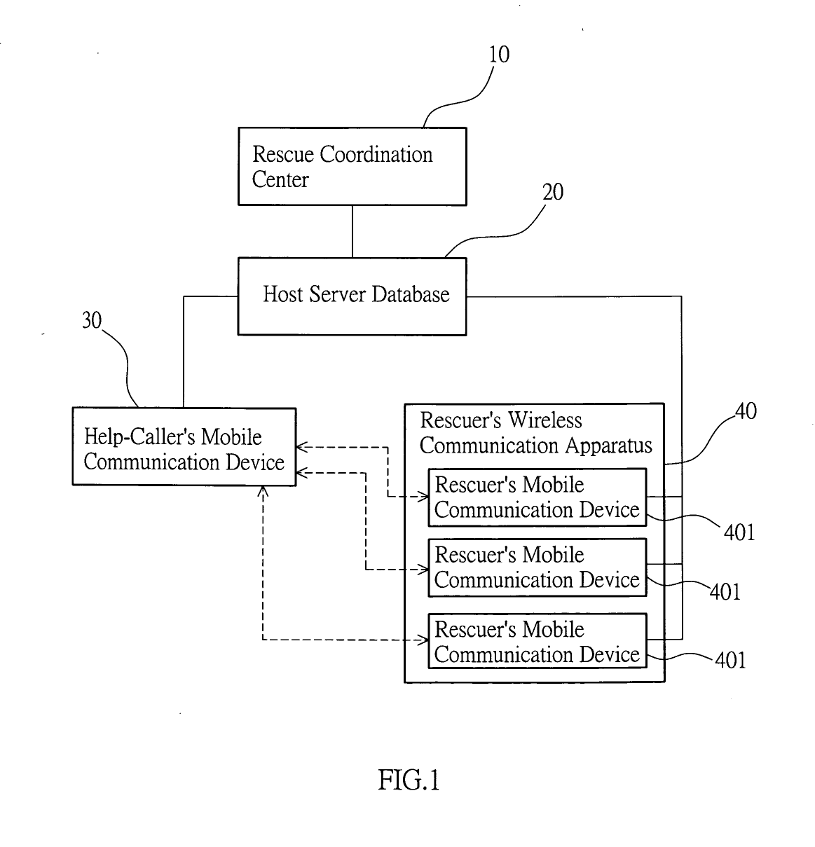

Referring to FIGS. 1, 2 and 3, a rescue coordination center 10 is connected with a host server database 20. The host server database 20 serves to receive a help-calling message coming from a help-caller's mobile communication device 30, and to send the help caller's help-calling message to a rescuer's wireless communication apparatus 40 that contains mobile communication devices 401 held by plural rescuers. The help-caller's mobile communication device 30 and every rescuer's mobile communication device 401 at different locations set each other as its Wi-Fi wireless communication base station hot spot or search plural help-calling service set identifiers (SSIDs) preloaded by the system and then establish wireless network connection with each other, so as to form a small local area network. According to the Wi-Fi connection between the two devices, the distance therebetween can be determined, and the distance can be used in calculation for accurately locating the help caller. The help-caller's mobile communication device 30 comprises: a controlling and processing unit 31, a positioning unit 32, an emergency help-calling unit 33, a wireless signal searching unit 34, a portable base station controlling unit 35, a status reporting unit 36, and a disaster information unit 37. Therein,

The controlling and processing unit 31 is coupled to the positioning unit 32, the emergency help-calling unit 33, the wireless signal searching unit 34, the portable base station controlling unit 35, the status reporting unit 36, and the disaster information unit 37. The controlling and processing unit 31 works with the positioning unit 32 to obtain information on the current location and sends the information to the emergency help-calling unit 33 and the host server database 20, and receives information on disasters such as earthquakes, fires, debris flow host . . . occurring at the place where the host server database 20 is present;

The positioning unit 32 works with the emergency help-calling unit 33 to send information on the help-caller's location to the controlling and processing unit 31, and provides the coordinates of the location where the help caller is, for the help caller's family and the rescue coordination center 10 to know where the help caller is;

The emergency help-calling unit 33 can be activated manually or automatically. It comprises a help-calling message sending unit 331 and a help-caller's alerting unit 332. The help-calling message sending unit 331 can make a phone call and send an SMS to a preset contact's telephone, and send out the help caller's name, a location message (via GPS), a survival message (via gyroscope) and a preloaded base station name for the remote host server database 20 to receive. Then the host server database 20 can inform clearly the rescue coordination center 10 of the location of the help caller affected by the disaster. The help-caller's alerting unit 332 may inform the help caller of the rescuers' arrival at the site by means of light, vibration and voice;

The wireless signal searching unit 34 works with the portable base station controlling unit 35 to alternately search or stop searching the base station name(s) of the preloaded rescuer's mobile communication device(s) 401 so as to establish connection thereto;

The portable base station controlling unit 35 works with the wireless signal searching unit 34 to alternately activate or deactivate the portable base station;

The status reporting unit 36 is manually controlled to report to the rescue coordination center 10 and the preset contact whether the help caller is safe, and this helps to rectify any false activation of the system;

The disaster information unit 37 serves to receive information on the disaster(s) at the site, and let the help caller being affected by the disaster(s) know more details about the disaster(s) information on the disaster(s) or provide the user in normal days with some knowledge about disaster prevention;

The rescuer's mobile communication device 401 comprises: an algorithm controlling unit 41, a positioning unit 42, an emergency rescue unit 43, a wireless signal searching unit 44, and a portable base station controlling unit 45.

The algorithm controlling unit 41 is coupled to the positioning unit 42, the emergency rescue unit 43, the wireless signal searching unit 44, and the portable base station controlling unit 45. The algorithm controlling unit 41 works with the positioning unit 42 to obtain the information on the current location and send the information to the emergency rescue unit 43 and the host server database 20, so that the rescue coordination center 10 can learn about its location, and calculate the distances of wireless connection between the wireless signal searching unit 44, the portable base station controlling unit 45 and the help-caller's mobile communication device.

The positioning unit 42 uses network map information to show the help-caller's coordinates location, and provided the rescue coordination center 10 with the location for its proper task appointment for rescue.

The emergency rescue unit 43 comprises a rescue detail providing unit 431 and a rescuer's alerting unit 432. The rescue detail providing unit 431 receives the help caller's name, the location message, the survival message, and the help-calling base station service set identifier from the remote host server database 20. The rescue coordination center 10 deploys rescuers according to the help caller's location. The rescuer's alerting unit 432 sends an arrival notice to the help caller, and informs the rescuer of the nearby help caller with light, vibration and voice.

The wireless signal searching unit 44 works with the portable base station controlling unit 45 to alternately search or stop searching the preloaded base station name of the rescuer's mobile communication device 401 for establishing connection.

The portable base station controlling unit 45 works with the wireless signal searching unit 44 to alternately activate or deactivate portable base station.

The composition and details of present invention are described below. As shown in FIG. 1, the disclosed system uses the existing wireless communication technology (3G and Wi-Fi) to enable a person affected by a disaster or an accident to upload a help-calling message using his/her help-caller's mobile communication device 30 (the device may be a mobile phone, a tablet computer, a smart watch, etc.) to the host server database 20 of the rescue coordination center 10. The rescue coordination center 10 thus can be well informed of the disaster and immediately direct the rescuers most close to the disaster area to perform rescue, thereby providing the earliest assistance. It also sends the help caller's help-calling message to the rescuer's wireless communication apparatus 40, so that the rescuers can know the number of people to be rescued and how they are injured on their way to the disaster area. After the rescuers arrive at the disaster area, the commander may deploy the rescuers each taking a mobile communication device 401 (the device may be a mobile phone, a tablet computer, and a smart watch, etc.) at various azimuths in the disaster area. The devices have wireless base station names authorized by the system, for the help-caller's mobile communication device 30 to search and establish connection thereto, thereby forming a small local area network. According to the connection, the distance between the help caller and the rescuer can be determined. Since distance calculation based on Wi-Fi feedback signals is a scientifically proven technology, the detailed explanation is omitted herein. The different azimuths and the rescuers' connection with the help caller can be used to calculate the help caller's distances from the rescuers. The distance data is then sent to the remote host server database 20, so that the rescue coordination center 10 can integrate the data and calculate the help caller's location accurately. Thereby, the rescuers can perform rescue accurately to save the help caller at the earliest possibility.

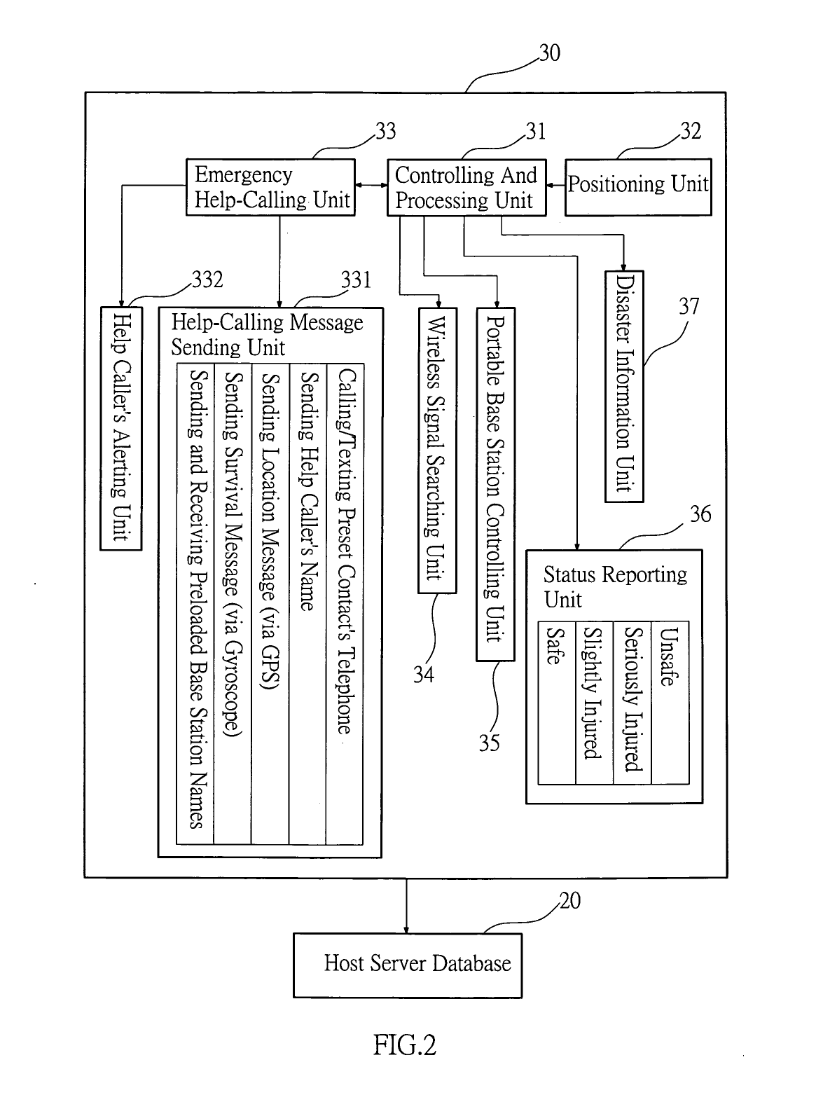

Referring to FIG. 2, in the disclosed system, the help-calling message sending unit 331 may automatically or be operated by the user manually to regularly upload coordinate data to the host server database 20, and can receive information about nearby disasters. The activation of the rescue mechanism may be manual by the user or automatic by the system. For automatic activation, the rescue mechanism is activated when: 1. a threshold present by the user is reached (such as an earthquake stronger than a magnitude of 5 . . . ); 2. the system detects abnormal data of the gyroscope in the mobile communication device (such as the data reflecting a sharp directional change and vibration that imply a sudden falling . . . ); and 3. the system's automatic activation mechanism is triggered (such as by an earthquake stronger than a magnitude of 6, or establishment of an on-site rescue station . . . ). When the emergency help-calling unit 33 is activated, the help-calling message sending unit 331 sends out the help-caller's location and the help-calling message, and the status reporting unit 36 feeds back the system with the help-caller's status as being safe, slightly injured, seriously injured or unsafe. Moreover, the feedback signal saying the help-caller's status as being “safe” can also act as a proof that the system's automatic m activation of the emergency help-calling unit 33 is false when disasters occur, so that the rescuers can be sent to save people really need rescue. Furthermore, when the rescuers arrive at the disaster area, the rescuer's alerting unit 432 worn by the rescuers can work with the positioning unit 42 to calculate the vicinity to the help caller. At this time, its sends an arrival notice to the help-caller's alerting unit 332, so that the help-caller's alerting unit 332 can give a notice to the help caller by means of light, vibration and voice. The rescuer's alerting unit 432 can also give out light, vibration and voice to inform the rescuer of the existence of a nearby help caller. The help caller can turn on the portable base station controlling unit 35, to allow the rescuer to search its Wi-Fi signal and establish connection thereto. Alternatively, the help caller may use the wireless signal searching unit 34 to search the Wi-Fi base station signal shared by the rescuer, so that the rescuers in various azimuths can establish connection successively, and calculate the relative distances. By using these relative distances, the help caller's location can be accurately determined.

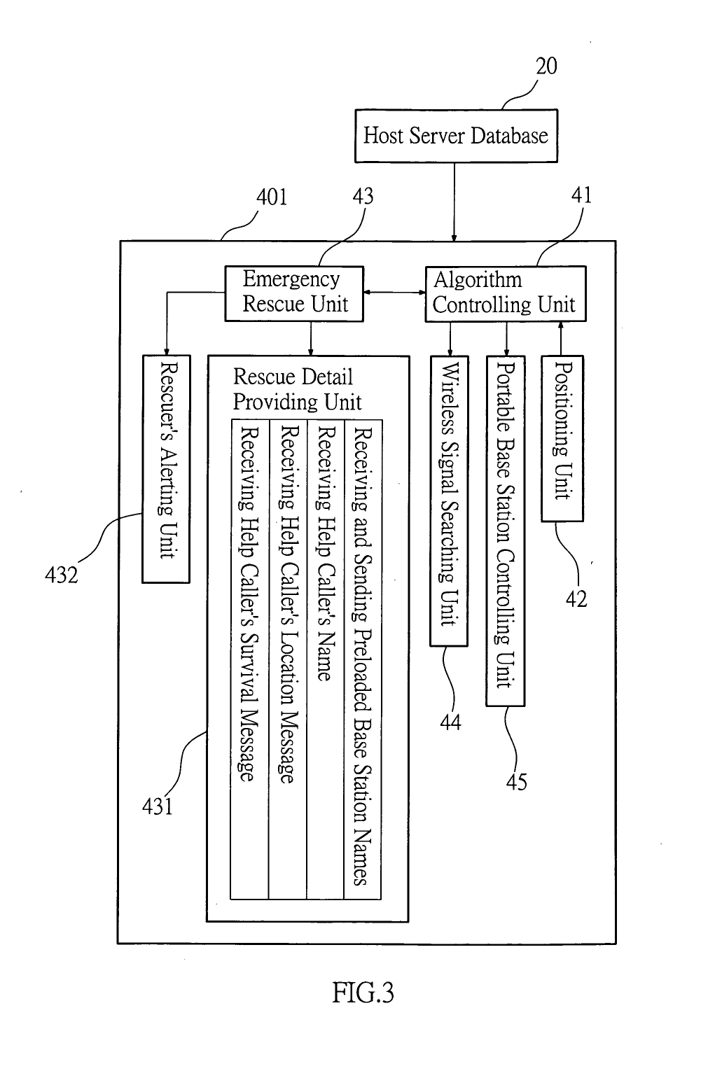

Referring to FIG. 3, in the disclosed system, when the rescue coordination center 10 receives a help-calling message from the host server database 20, the rescuers can download the help caller's data from the host server database 20. After a rescuer arrives at the disaster area, the rescuer's alerting unit 432 can send out an arrival notice, and the rescue detail providing unit 431 can inform the nearby help caller of its wireless communication network name. The help-caller's alerting unit 332 then uses light, vibration and voice to alert the help caller. The portable base station controlling unit 45 can be turned on to allow the help caller searching Wi-Fi signals and establishing connection thereto. Alternatively, it is possible that the rescuer uses the wireless signal searching unit 44 to search the Wi-Fi base station signal shared by the help caller. When the rescuers at various azimuths establish connection with the help caller successively, the relative distance therebetween can be calculated and used to determine the help caller's location accurately.

When the connection between the help caller and the rescuers is established, the rescuers' mobile communication devices 401 record the feedback Wi-Fi signal. By using the signal magnitude and the relative distances, the radius of the distance between the help caller and every rescuer can be determined. Then by integrating the radius distance data from all the rescuers' mobile communication devices 401, the relative azimuths of the help caller to the rescuers can be determined as follows:

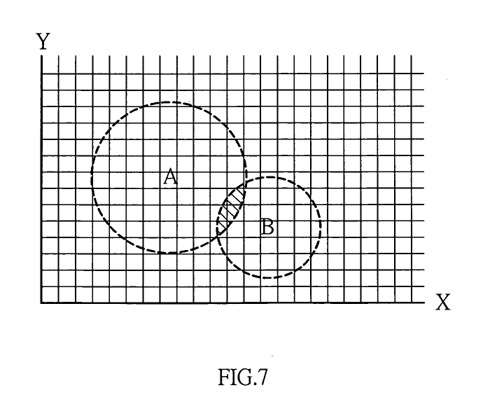

1. Taking two signal records for example, referring to FIG. 7, the rescuer A and the rescuer B have obtained their distances from the help caller, respectively. The radius of A's distance and the radius of B's distance are partially overlapped, meaning that the help caller's signal is issued from this overlapped area. Thus, the search scope is narrowed to the identified azimuth, thereby reducing the time required by large-area search.

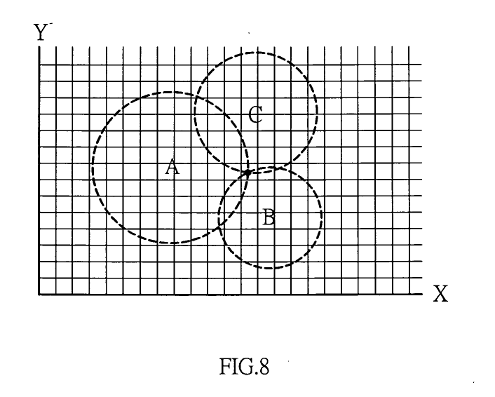

2. Taking three signal records for example, referring to FIG. 8, the rescuer A, the rescuer B, and the rescuer C have obtained their distances from the help caller, respectively. The radius of A's distance, the radius of B's distance, and the radius of C's distance are joined at a point, meaning that the help caller's signal is issued right at this point. Thus, the help caller can be accurately located at this point.

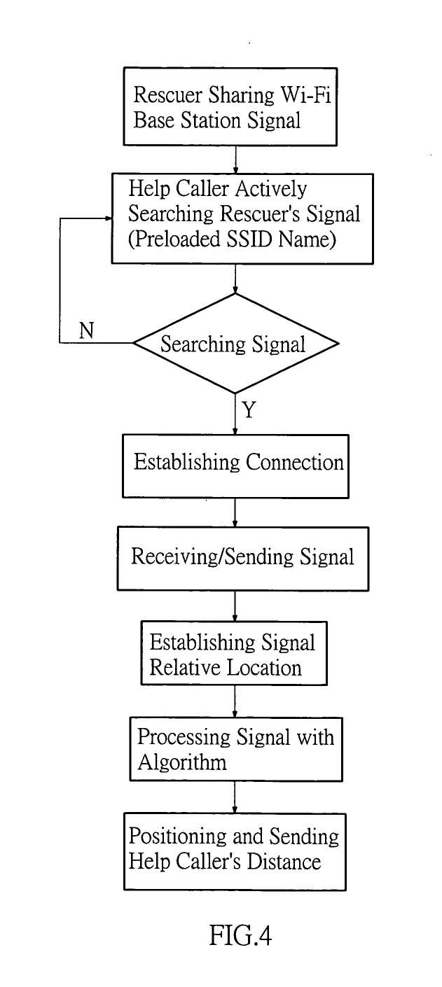

Please refer to FIG. 4 through FIG. 6 for the flowchart of the rescue mechanism of the present invention. When the help caller is informed of that the rescuers have arrived at the disaster area and are deployed at different azimuths, the rescue mechanism can be performed in three ways:

1. As shown in FIG. 4, the rescuer shares a Wi-Fi base station signal, and the help caller actively searches the rescuer's network signal. If the signal is found successfully, the both devices establish connection, and create signal relative location by sending/receiving signals. The signals can be then processed with a certain algorithm to provide the help caller's relative distance. The data is sent to the host server database 20 for the rescue coordination center 10 to integrate and calculate.

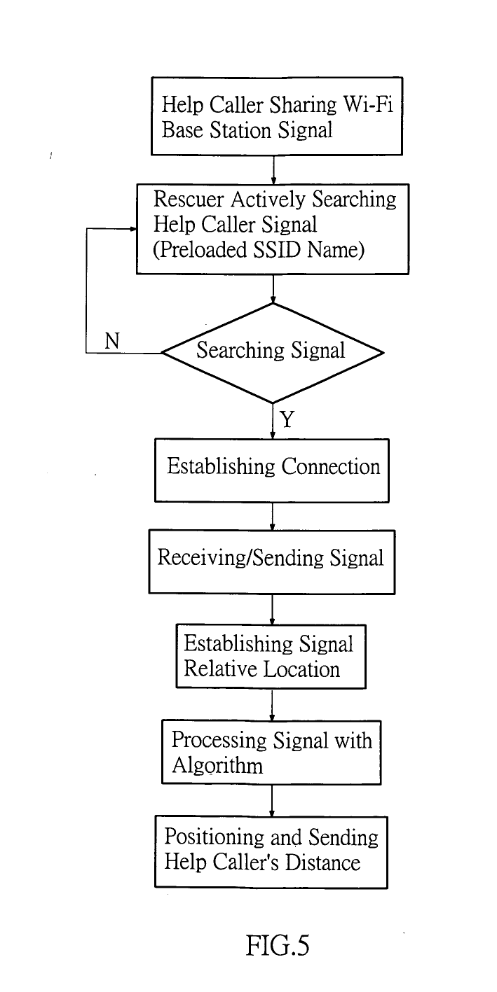

2. As shown in FIG. 5, the help caller shares a Wi-Fi base station signal, and the rescuer actively searches the network signal. If the signal is found successfully, the both devices establish connection, and create signal relative location by sending/receiving signals. The signals can be then processed with a certain algorithm to provide the help caller's relative distance. The data is sent to the host server database 20 for the rescue coordination center 10 to integrate and calculate.

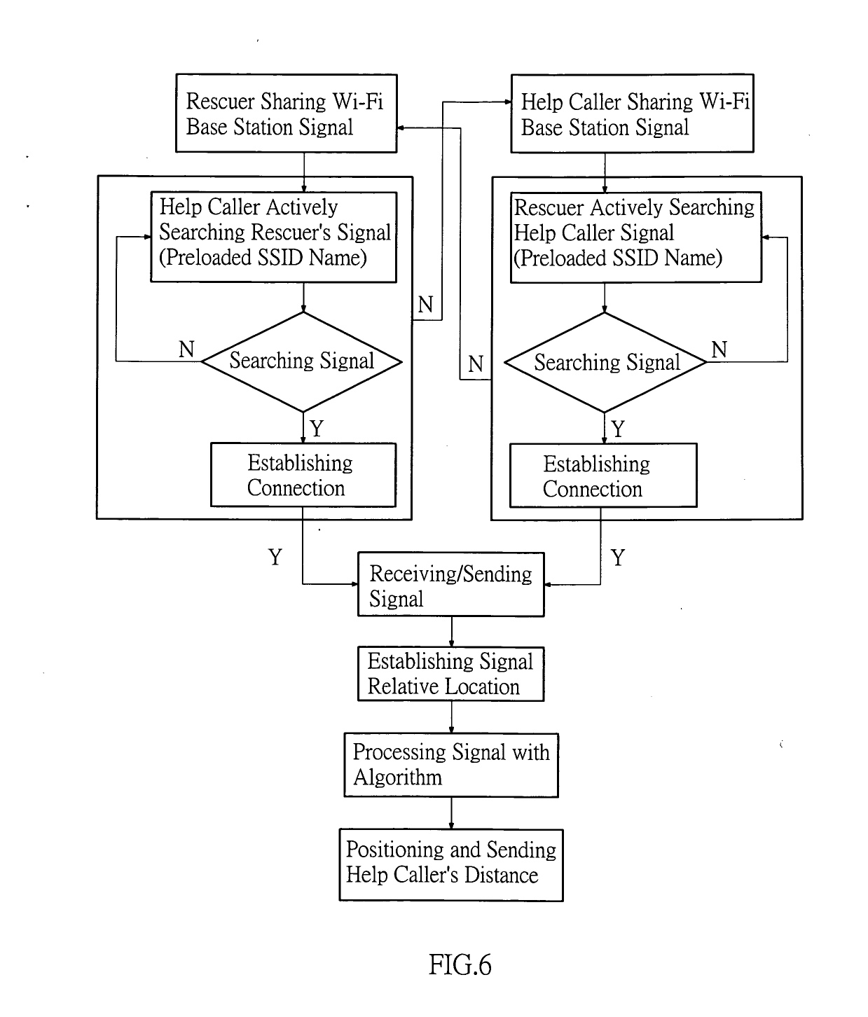

3. As shown in FIG. 6, the help caller shares a Wi-Fi base station signal, and the rescuer actively searches the network signal. If the signal is not found successfully, the system automatically makes the rescuer share a Wi-Fi base station signal instead, and males the help caller actively search the rescuer's network signal. The process may be alternately repeated until the connection is established, thereby enabling prompt search and rescue within the golden window.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A wireless communication system for human rescue, comprising a rescue coordination center and a host server database that are mutually connected, the host server database serving to receive a help-calling message from a mobile communication device of a help-caller and send the help caller's help-calling message to a rescuer's wireless communication apparatus that includes a plurality of mobile communication devices held by rescuers, the help-caller's mobile communication device establishing wireless network connection with the rescuer's mobile communication devices at various azimuths, respectively, so that a distance between every said rescuer's mobile communication device and the help-caller's mobile communication device is derived using Wi-Fi connection therebetween, and the help caller is located accurately using the plural distances between the rescuers' and the helper's mobile communication devices; the help-caller's mobile communication device comprising: a controlling and processing unit, a positioning unit, an emergency help-calling unit, a wireless signal searching unit and a portable base station controlling unit, therein,
the controlling and processing unit being coupled with the positioning unit, the emergency help-calling unit, the wireless signal searching unit, and the portable base station controlling unit; the controlling and processing unit working with the positioning unit to obtain information on a current location, and sending the information to the emergency help-calling unit and the host server database;
the positioning unit working with the emergency help-calling unit to send the information on the help-caller's location to the controlling and processing unit;
the emergency help-calling unit, comprising: a help-calling message sending unit and a help-caller's alerting unit; the help-calling message sending unit serving to send the help-calling message for the host server database to receive, and inform the rescue coordination center of a place where a disaster just happened; and the help-caller's alerting unit serving to inform arrival of any of the rescuer;
the wireless signal searching unit working with the portable base station controlling unit to alternately search or stop searching a base station name preloaded in the rescuer's mobile communication device for establishing connection thereto;
the portable base station controlling unit working with the wireless signal searching unit to alternately activate or deactivate the portable base station;
the rescuer's mobile communication device comprising: an algorithm controlling unit, another positioning unit, an emergency rescue unit, another wireless signal searching unit, and another portable base station controlling unit, therein
the algorithm controlling unit being coupled to the positioning unit, the emergency rescue unit, the wireless signal searching unit, and the portable base station controlling unit; the algorithm controlling unit working with the positioning unit to obtain the information on the current location and send the information to the emergency rescue unit and the host server database, so as to enable the rescue coordination center to learn about its location, and calculate wireless connection distances between the wireless signal searching unit, the portable base station controlling unit, and the help-caller's mobile communication device, and send the distances to the host server database for the rescue coordination center to integrate;
the positioning unit serving to use network map information to show coordinates of its location, and provide the coordinates to the rescue coordination center for task assignment;
the emergency rescue unit comprising a rescue detail providing unit and a rescuer's alerting unit; the rescue detail providing unit serving to receive the help caller's help-calling message from the remote host server database; the rescuer's alerting unit serving to send arrival notice to the help caller and alert the rescuer of the help caller nearby;
the wireless signal searching unit working with the portable base station controlling unit to alternately search or stop searching the base station name preloaded in the rescuer's mobile communication device for establishing connection;
the portable base station controlling unit working with the wireless signal searching unit to alternately activate or deactivate the portable base station.

2. The wireless communication system for human rescue of claim 1, wherein the emergency help-calling unit is manually or automatically activated.

3. The wireless communication system for human rescue of claim 1, wherein the help-caller's alerting unit and the rescuer's alerting unit give alerts by means of light, vibration and voice.

4. The wireless communication system for human rescue of claim 1, wherein each of the help-caller's mobile communication device and the rescuer's mobile communication devices is a mobile phone, a tablet computer, or a smart watch.

5. The wireless communication system for human rescue of claim 1, wherein the help-calling message includes the help caller's name, a location message, a survival message, and a preloaded base station name.

6. The wireless communication system for human rescue of claim 1, wherein the help-caller's mobile communication device further comprises a disaster information unit and is coupled to the controlling and processing unit, for receiving information on disasters happening at where the help-caller's mobile communication device is.

7. The wireless communication system for human rescue of claim 1, wherein the help-caller's mobile communication device further comprises a status reporting unit and is coupled to the controlling and processing unit.

8. The wireless communication system for human rescue of claim 7, wherein the status reporting unit reports the help-caller as being safe, slightly injured, seriously injured or unsafe.
